(19) United States
(12) Patent Application Publication
(10) Pub. No.: US 2015/0109783 A1
(43) Pub. Date: Apr. 23, 2015

(54) LED LIGHT STRING

(71) Applicant: YAU-CHIN PENG, Hsinchu City (TW)

(72) Inventor: YAU-CHIN PENG, Hsinchu City (TW)

(21) Appl. No.: 14/060,636

(22) Filed: Oct. 23, 2013

(51) Int. Cl. H05B 33/08

(52) U.S. Cl. CPC H05B 33/0821
USPC 362/249.06

(57) ABSTRACT

The present invention provides an improvement of LED light string structure. The LED light string includes a controller, having an electricity plug, connected with a plurality of LED light bulbs in serial arrangement and a terminal socket at an end of the light string as characterized in that a main control IC is within the controller and a LED illuminator and an associate control IC are within each LED light bulb so as to simultaneously control the operation of entire LED light string by both the main control IC within the controller and the associate control IC within the LED light bulb. Thereby time difference does not exist between the flashing rhythms of all LED light bulbs in serial in order to improve the flashing effect of entire LED light string toward perfection.

### TECHNICAL FIELD OF THE INVENTION

The present invention is related to an improvement of LED light commodity, particularly to an improvement of a control structure of a LED light string.

### DESCRIPTION OF THE PRIOR ART

The present invention is related to an improvement of a LED light string with a controller. As shown in FIG. 1, a schematic diagram of LED light string (20) arrangement mainly includes a controller (10), which is provided with an electricity plug (11) and a main control IC (12), connected with a conducting wire (22) and a plurality of LED light bulbs (21), each of which has a LED illuminator (212), in serial arrangement with a terminal socket (30) provided at an end of the LED light string (20). The operation of the LED light string (20) is that, after the electricity plug (11) is connected to an electricity source, the flashing of all LED light bulbs (21) of the LED light string (20) is only controlled by the main control IC (12) within the controller (10). As for each LED light bulb (21) of the LED light string (20), a small time difference exists between the flashing rhythms of each LED light bulb (21) so as to cause errors in the flashing rhythm of entire LED light string (20). Therefore the flashing effect of entire LED light string (20) is so significantly impacted toward imperfection that demands improvement.

Further, FIG. 3 shows a LED light set in a form of window shade having a main LED light string and an associate LED light string. The arrangement of the LED light set mainly includes a controller (10), which is provided with an electricity plug (11) and a main control IC (12), connected with a main light string (20′), which is assembled by a main conducting wire (22′) and a plurality of main light bulbs (21′) in serial arrangement with a terminal socket (30) provided at an end of the main light string (20′) while each main light bulb (21′) is individually connected with an associate light string (40), which is assembled by an associate conducting wire (42) and a plurality of associate light bulbs (41), thereby the associate light strings (40) are in parallel to each other and each main light bulb (21′) and each associate light bulb (41) has a LED illuminator. The operation is that, after the electricity plug (11) is connected to an electricity source, the flashing of all light bulbs of both the main light strings (20′) and the associate light strings (40) is only controlled by the main control IC (12) within the controller (10). As for each main light bulb (21′), the error in the flashing rhythm is relatively small but a relatively obvious time difference exists in the flashing rhythm of each associate light bulb (41) of the associate light strings (40) in parallel arrangement. An error is thus caused between the flashing rhythm of each associate light bulb (41) of the associate light string (40) in parallel arrangement and the flashing rhythm of the main light bulb (21′) of the main light string (20′). Such error impacts the flashing effect of the entire LED light set so much toward imperfection that demands improvement.

### SUMMARY OF THE INVENTION

An objective of the present invention, an improvement of LED light string structure, is to provide a main control IC within a controller of a LED light string and both a LED illuminator and an associate control IC within each LED light bulb so as to utilize both the main control IC within the controller and the associate control IC within each LED light bulb to simultaneously control the operation of entire light string. Thereby the time difference does not exist between the flashing rhythms of all LED light bulbs in serial arrangement so as to improve the flashing effect of entire LED light string toward perfection.

### BRIEF DESCRIPTION OF THE DRAWINGS

FIG. 1 is a schematic diagram illustrating the LED light string arrangement of the prior art.

FIG. 2 is a schematic diagram illustrating the LED light string arrangement of the present invention.

FIG. 3 is a schematic diagram illustrating the LED light set in the form of window shade of the prior art.

FIG. 4 is a schematic diagram illustrating the LED light set in the form of window shade of the present invention.

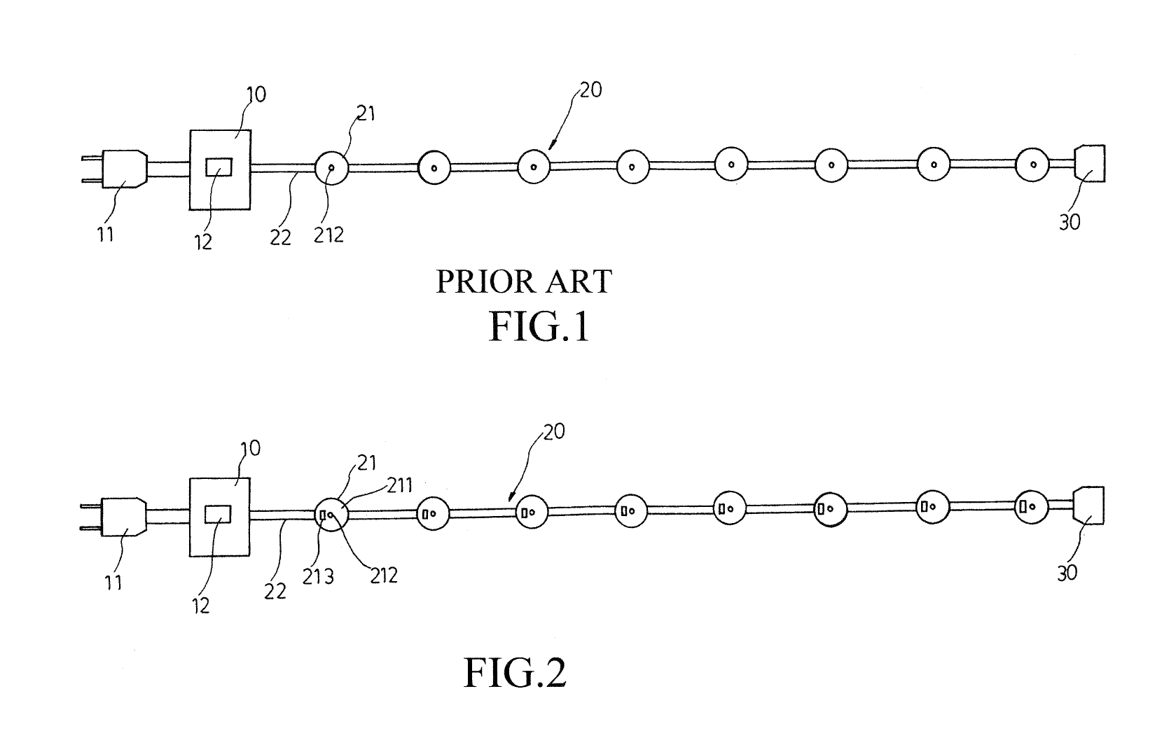

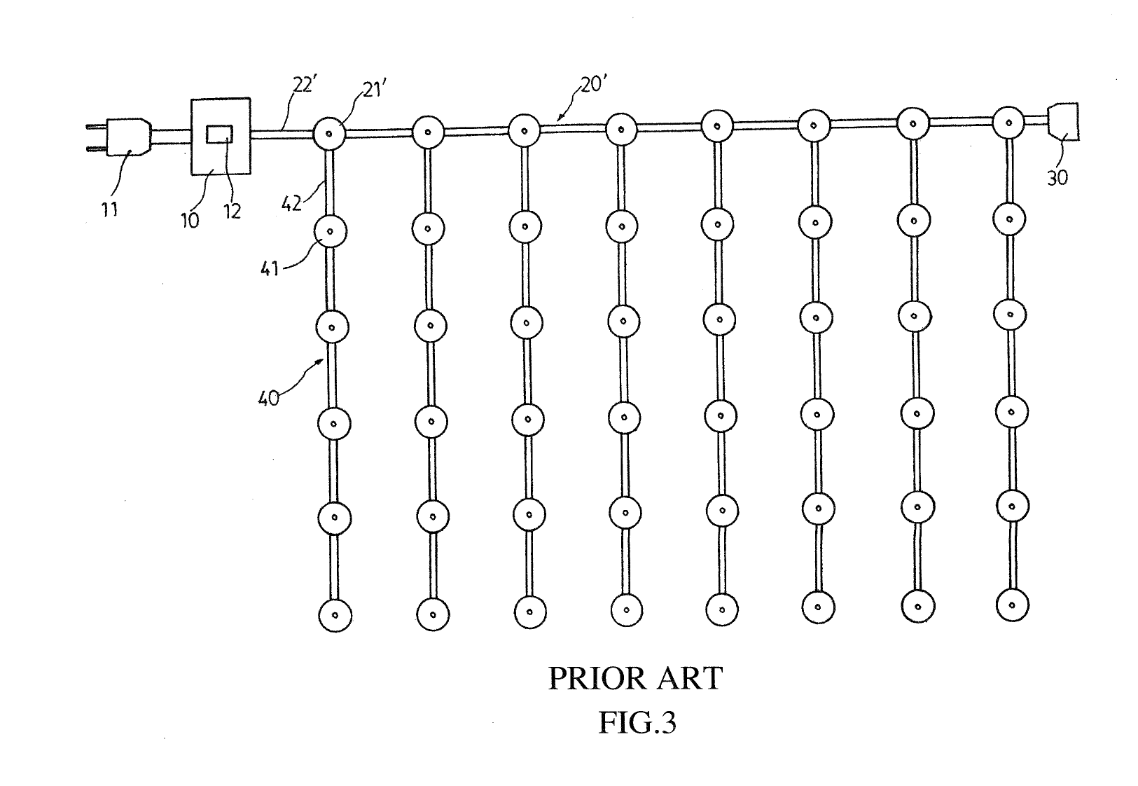

### DETAILED DESCRIPTION OF THE PREFERRED EMBODIMENTS

Please refer FIG. 2, an embodiment of the improvement of LED light string structure of the present invention that mainly includes a controller (10) with one end provided with an electricity plug (11) and the other end connected with a LED light string (20), which is assembled by a conducting wire (22) and a plurality of LED light bulbs (21) in serial arrangement, and a terminal socket (30) provided at an end of the LED light string (20) as characterized in that a main control IC (12) is provided within the controller (10) while a LED illuminator (212) and an associate control IC (213) are provided within a light bulb post (211) of each LED light bulb (21). The operation of this embodiment is that, after the electricity plug (11) is connected to an electricity source, the flashing mode of all LED light bulbs (21) of the entire LED light string (20) is controlled by both the main control IC (12) within the controller (10) and the associate control IC (213) within each LED light bulb (21) in a simultaneous and synchronized manner. Thereby the time difference does not exist between the flashing rhythms of all LED light bulbs (21) in serial arrangement of LED light string (20) so as to improve the flashing effect of entire LED light string (20) toward perfection.

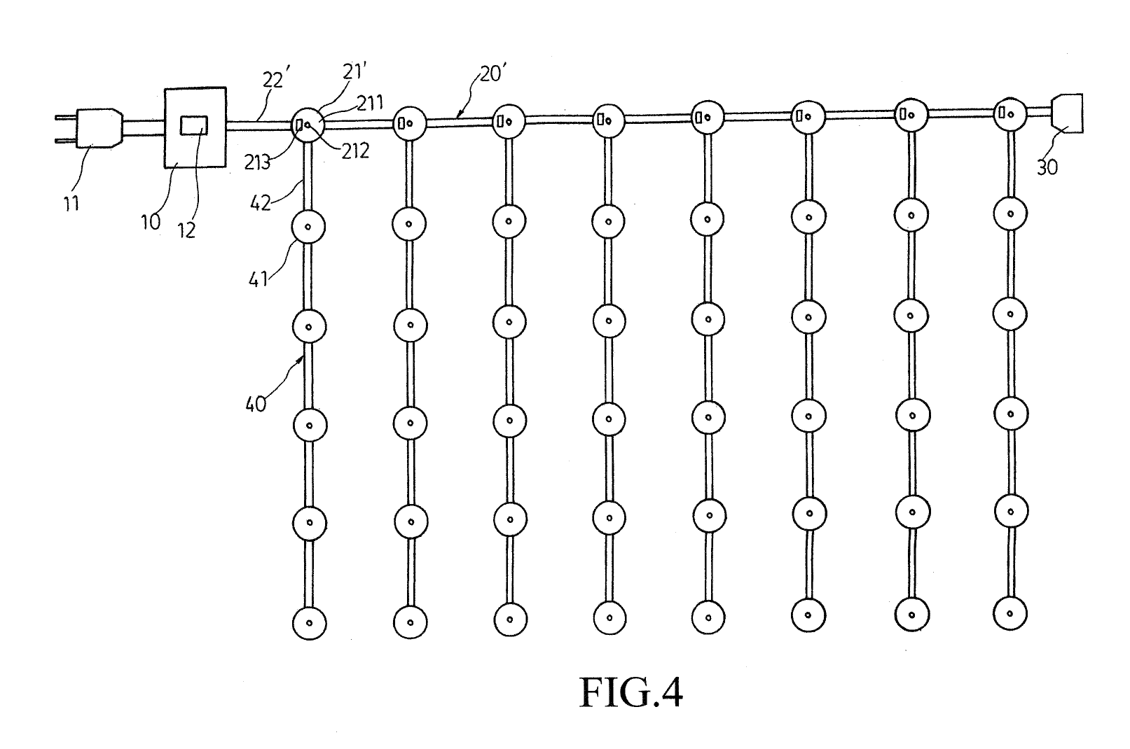

Further please refer FIG. 4, an embodiment of a LED light set in the form of window shade having a main light string (20′) and a plurality of associate light string (40). The structure arrangement of the LED light set mainly includes a controller (10), which is provided with an electricity plug (11) and a main control IC (12), connected with a main light string (20′), which is assembled by a main conducting wire (22′) and a plurality of light bulbs (21′) in serial arrangement, with a terminal socket (30) provided at an end of the main light string (20′) that each main light bulb (21′) is individually connected with an associate light string (40), which is assembled by an associate conducting wire (42) and a plurality of associate light bulbs (41) in serial arrangement so as to have the associate light strings (40) in parallel arrangement. This embodiment is characterized in that the main control IC (12) is provided within the main controller (10) while a LED illuminator (212) and an associate control IC (213) are provided within a light bulb post (211) of each main light bulb (21′). The operation of the LED light set is that, after the electricity plug (11) is connected to an electricity source, the flashing of every main light bulb (21′) of the main light string (20′) is controlled by the main control IC (12) within the controller (10) while the flashing of all associate light bulb (41) of each associate light string (40) is controlled by the associate control IC (213) within each main light bulb (21′) in a simultaneous and synchronized manner. Thereby the time difference does not exist between the flashing rhythms of all main light bulbs (21′) in serial arrangement of the main light string (21′) and the flashing rhythm of each associate light bulb (41) of the associate light string (40) in parallel arrangement so as to improve the flashing effect of the entire LED light set toward perfection.

I claim:

1. An improvement of a LED light string structure, the LED light string comprising a controller provided with an electricity plug and connected with a plurality of LED light bulbs assembled in serial arrangement with a terminal socket provided at an end of the LED light string characterized in that a main control IC is provided within the controller while a LED illuminator and an associate control IC are provided within each of the plurality of LED light bulbs whereby said main control IC within the controller and said associate control IC within each LED light bulb are utilized to simultaneously control the LED light string operation.

2. An improvement of a LED light string structure comprising a controller provided with an electricity plug and connected with a main light string, assembled by a plurality of main light bulbs in serial arrangement while each main light bulb individually connected with an associate light string which is assembled by an associate conducting wire and a plurality of associate light bulbs in serial arrangement, with a terminal socket provided at an end of the main light string characterized in that a main IC is provided within the controller while a LED illuminator and an associate control IC are provided within each main light bulb whereby both said main control IC and said associate control IC are utilized to control the operations of both the main light string and the associate light strings in a simultaneous and synchronized manner.
